(19) United States
(12) Patent Application Publication
(10) Pub. No.: US 2023/0325734 A1
(43) Pub. Date: Oct. 12, 2023

(54) METHODS OF ASSIGNMENT IN A DYNAMIC DISTRIBUTIONAL SYSTEM

(71) Applicant: Personalized Beauty Discovery, Inc., San Mateo, CA (US)

(72) Inventors: John P. LeFlohic, San Mateo, CA (US); James D. Flick, Copperopolis, CA (US); Gautham Adhithya Thirunavukkarasu, Thiruporur (IN)

(21) Appl. No.: 17/716,806

(22) Filed: Apr. 8, 2022

(51) Int. Cl. G06Q 10/06; G06Q 10/04

(52) U.S. Cl. CPC G06Q 10/063112; G06Q 10/0639; G06Q 10/04

(57) ABSTRACT

A dynamic assignment system or distributed resource allocation system and methods performed therein are disclosed. One method performed by the system is directed towards assigning a new member to a full receiver in a dynamic assignment system. Another method performed by the system is directed towards determining a best path between two receivers in a dynamic assignment system. Another method performed by the system is directed towards monitoring a receiver reassignment of a member in a dynamic assignment system. An assignment processing unit of the dynamic assignment system programmed to perform the preceding methods is also disclosed.

### BACKGROUND

There are many business models from which a vendor may choose to sell products to customers. One of these business models offer subscription services to subscribers (i.e., customer), where such service could offer a limited number of products to their subscribers on a periodic basis, e.g., a monthly basis. A vendor could enter into an arrangement in which each subscriber user receives a monthly shipment of a limited number of products from the products that the vendor has available to sell.

For instance, assume that each customer of a vendor provides each customer with five products from fifty stocked or accessible products on a monthly subscription basis. The vendor could choose the five products to provide to the customer each customer, some of them based upon a known customers' characteristics, preferences, and purchasing history. Of the five, the vendor may select two of them, and the remaining forty-eight could be divided equally into three “choice groups” such that each choice group has eighteen products. The customer may then choose one of the eighteen in each choice group.

Ideally, the vendor would simply send each customer his or her favorite products; unfortunately, there may be many reasons why the vendor cannot. For instance, the quantities of each product that are stocked by the vendor may differ due to a limited number of products that are available to the vendor for purchase. Also, there may be certain products that cannot be provided to certain customers. For example, a customer could be allergic to a product(s), and/or one or more states of the United States may ban or place a restriction on a product(s) if it contains particular chemicals or ingredients. If faced with such situation, the vendor will want to avoid assigning such product(s) to the customer should.

In some business models, the vendor may have a warehouse in which products are assembled into combos and sent to its customers. If the vendor has a customer base of millions of subscribers, the vendor faces a large possible combinations—or “combos”—to fulfill each month.

To allocate enough time for employees to assemble combos for a customer base of millions of customers, the vendor may have to limit the number of combos that will be assembled (e.g., two-hundred fifty combos). By limiting the number of combos, an assembly line could be employed to assemble tens of thousands (or more) of each combo in batches. The total number of combos assembled will depend on the number of customers that will receive them. Hence, the vendor needs to carefully assign the products of each combo to the customers in a manner that maximizes overall customer-combo scores.

“Traditional” techniques—forms of assignment problems—may be employed to assign subscribers to products when all of the subscribers and products are known ahead of time. For example, a “minimum cost, maximum flow” (min-cost max-flow) technique may be employed to minimize costs to deliver a maximum flow of products to the subscribers; however, this technique does not allow the vendor to assign subscribers one at a time, i.e., sequentially, in an optimal way that is reasonably fast.

A degenerate solution would be to apply a full min-cost max-flow technique after each time a subscriber is added; however, the solution may be too slow to meet the demands of the vendor. More importantly, the amount of processing time would be significantly increased.

### SUMMARY

Embodiments of the inventive concepts disclosed herein are directed to an assignment system which injects computer processing efficiency by providing an iterative solution to the assignment problem arising from an addition of new and unknown subscribers. The iterative solution—distinct from solutions that solve static forms of assignment problems—provides for optimal results and allows for an opaque stream of new and unknown subscribers to be added to the process one at a time while maintaining optimality along the way and reducing the amount of processing time required by existing assignment techniques.

In one aspect, embodiments of the inventive concepts disclosed herein are directed to a method for allocating distributed resources or assigning a new member to a full receiver in a dynamic assignment system or distributed resource allocation system. The method could include receiving a new member of the system, assigning the new member to a receiver, reassigning an existing member in the assigned receiver to a destination receiver, and determining a best path and a best path cost for the assigned receiver.

In a further aspect, embodiments of the inventive concepts disclosed herein are directed to a method for determining a best path between two receivers in a dynamic assignment system or distributed resource allocation system. The method could include assigning a new member to one receiver, creating a listing of best cost deltas and corresponding members for each destination receiver, and determining a best path and a best path cost of the assigned receiver.

In a further aspect, embodiments of the inventive concepts disclosed herein are directed to a method for monitoring a receiver reassignment of a member in a dynamic assignment system of distributed resource allocation system. The method could include reassigning a member from one full receiver to a destination receiver of a plurality of destination receivers, amending at least one listing of the assigned receiver, amending each listing of the destination receiver upon meeting a boundary cost criteria, determining a first best path to an open receiver and a first best path, and determining a second best path to an open receiver and a second best path cost.

In a further aspect, embodiments of the inventive concepts disclosed herein are directed to a device employed in a dynamic assignment system. The method could include receiving a sequence of new members, creating a plurality of nodes and a plurality of edges of a directed graph, and determining a minimum cost for each full receiver.

### BRIEF DESCRIPTION OF THE DRAWINGS

For a fuller understanding of the inventive embodiments, reference is made to the following description taken in connection with the accompanying drawings in which:

FIG. 1 depicts a functional block diagram of a dynamic assignment system, in accordance with some embodiments;

FIGS. 2A through 2B illustrate tables of ball-cup scores and cup capacities, in accordance with some embodiments;

FIGS. 3A through 3E illustrate an assignment of new ball performed by the dynamic assignment system, in accordance with some embodiments;

FIGS. 4A through 4E illustrate an assignment of a second new ball performed by the dynamic assignment system, in accordance with some embodiments;

FIGS. 5A through 5E illustrate an assignment of a third new ball performed by the dynamic assignment system, in accordance with some embodiments;

FIGS. 6A through 6E illustrate an assignment of a fourth new ball performed by the dynamic assignment system, in accordance with some embodiments;

FIGS. 7A and 7K illustrate an assignment of a fifth new ball performed by the dynamic assignment system, in accordance with some embodiments;

FIG. 8 depicts an exemplary embodiment of a flowchart disclosing a method for assigning a new member of a sequence of new members to one receiver of a plurality of receivers, in accordance with some embodiments;

FIG. 9 depicts an exemplary embodiment of a flowchart disclosing method for determining a best path between two receivers in a system of a plurality of receivers, in accordance with some embodiments;

FIG. 10 depicts an exemplary embodiment of a flowchart disclosing a method for monitoring a receiver reassignment of a member in a system of a plurality of receivers, in accordance with some embodiments; and

FIG. 11 depicts an exemplary embodiment of a flowchart disclosing a method for determining minimum costs for a plurality of receivers in an assignment system receiving a sequence of new members, in accordance with some embodiments.

### DETAILED DESCRIPTION

In the following description, several specific details are presented to provide a thorough understanding of embodiments of the inventive concepts disclosed herein. One skilled in the relevant art will recognize, however, that the inventive concepts disclosed herein can be practiced without one or more of the specific details or in combination with other components. In other instances, well-known implementations or operations are not shown or described in detail to avoid obscuring aspects of various embodiments of the inventive concepts disclosed herein.

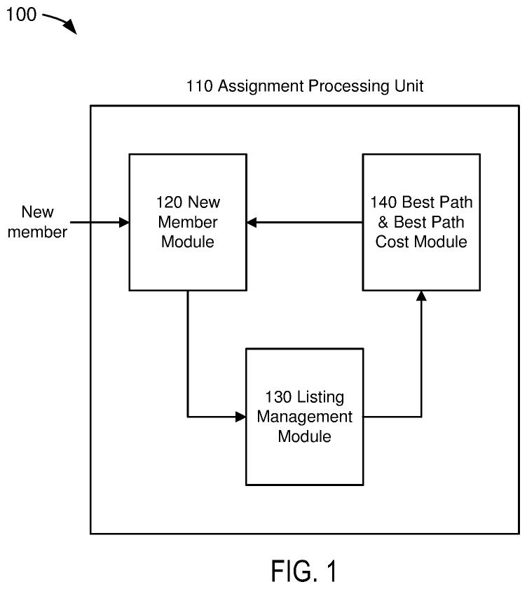

Referring to FIG. 1, an embodiment of a dynamic distributional system 100 suitable for implementation of the inventive concepts described herein. Dynamic distributional system 100 facilitates the vendor's ability to rapidly assign new customers to combos as they, for example, visit the vendor's e-commerce platform. From the scenario discussed above in which there are millions of customers and only two-hundred fifty combos, it is simply prohibitive for computerized processing to re-optimize all of the two-fifty customer-combo assignments from scratch each time a new user is added as would be performed in the min-cost max-flow method—a “from scratch” method. Using the dynamic assigner disclosed herein, an inverse proportionality is favorably recognized. When fewer combos are filled, more users or subscribers may be assigned, followed by a steady reduction of assignments as more combos become filled.

Dynamic distributional system 100 includes an assignment processing unit (APU) 110 with a new member module 120, a listing management module 130, and a best path and best path cost (BPBPC) module 140.

APU 110 could include any electronic data processing unit which executes software or computer instruction code that could be stored, permanently or temporarily, in a digital memory storage device or a non-transitory computer-readable media (generally, memory) including, but not limited to, cloud storage, random access memory (RAM), read-only memory (ROM), compact disc (CD), hard disk drive, diskette, solid-state memory, secure digital cards, and/or compact flash cards. The PU 150 may be driven by the execution of software or computer instruction code containing algorithms developed for the specific functions embodied herein. For the embodiments herein, the term “processor” is not limited to one processing unit and its meaning is not intended to be construed narrowly. For instance, APU 110 could also include more than one electronic data processing unit. In some embodiments, APU 110 could be a processor(s) used by or in conjunction with any other system(s) which may benefit from the performance of the functions embodied herein.

In some embodiments, the terms “programmed” and “configured” are synonymous. APU 110 may be electronically coupled to systems and/or sources to facilitate the receipt of input data. In some embodiments, operatively coupled may be considered as interchangeable with electronically coupled. It is not necessary that a direct connection be made; instead, such receipt of input data and the providing of output data could be provided through a bus, through a wireless data/communications network, or as a signal received and/or transmitted by APU 110 via a physical or a virtual computer port. APU 110 may be programmed or configured to execute the method discussed in detail below. In some embodiments, APU 110 may be programmed or configured to receive data from other system(s) which may benefit from the performance of the functions embodied herein. In some embodiments, APU 110 may be programmed or configured to provide output data to various systems and/or units which may benefit from the performance of the functions embodied herein.

New member module 120 could be configured to receive a sequential stream of new members—one member at a time—into the dynamic distributional system 100 having a plurality of members and a plurality of receivers, where each receiver is configured to receive a number of members equal to its capacity. It should be noted that the term “member” includes any person, place, or thing that could be assigned, and the term “receiver” could be any person, place, or thing to which the member is assigned.

With each new member, new member module 120 could receive a plurality of best path costs from BPBPC 140 and a plurality of member-receiver scores of the new ball to determine a receiver to which the new member will be assigned as disclosed below. Each best path cost could correspond to one receiver, and each member-receiver score could correspond to one receiver. For each receiver, the member-receiver score corresponding to the receiver may be added to the receiver's best path cost, and the receiver yielding the greatest sum of the score and the cost may be the receiver to which the new ball is assigned.

Listing management module 130 could be configured to receive new ball assignment information from new member module 120, and create and maintain best cost deltas listings for each receiver as disclosed below. Each listing includes a best cost and boundary cost determined by listing management module 130 from differences of member-receiver scores, i.e., cost deltas, between receivers. Listing management module 130 may also assist reassignments of a member(s) through a process of amending one or more listings in response to receiving assignment information of the new ball, where each reassignment may be determined by one or more best costs appearing on one or more listing(s) as maintained by listing management module 130.

BPBPC 140 may be configured to receive reassignment information from listing management module 130, and determine best path and best path cost of one or more members in response as disclosed below. The determination of best cost may be provided to, i.e., made available to, new member module 110 for an assignment of the next new ball.

To illustrate the assignment technique disclosed herein and performed by APU 110, an exemplary scenario is provided in which customers (e.g., users) may be assigned to combination of products in a dynamic situation in which the customers are not known prior to joining dynamic distributional system 100.

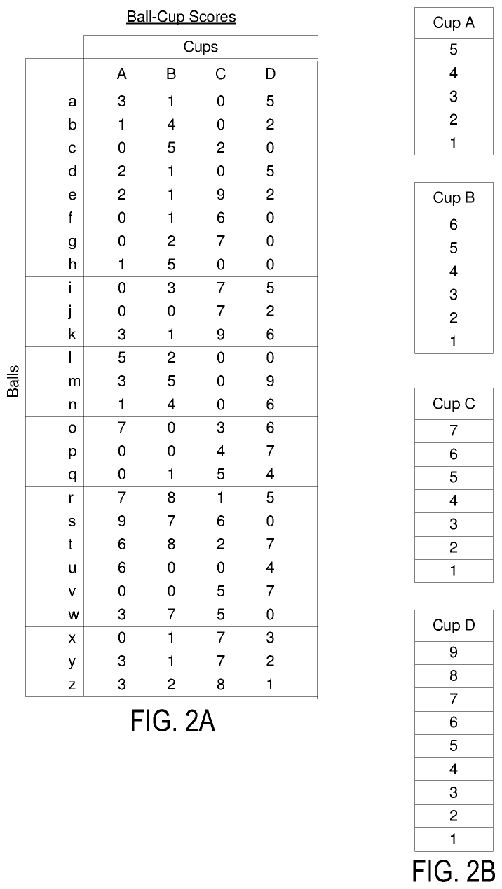

Referring to FIG. 2A, a table of ball-cup scores is presented where there are four cups A through D, inclusive, and twenty-six balls a through z, inclusive. It should be noted that the terms “ball” and “cup” are interchangeable with and used in lieu of “member” and “receiver,” respectively.

Each ball is received sequentially one at a time, and neither the identity of the ball nor the ball's ball-cup scores are known until after it has been received. Referring to FIG. 2B, the ball capacity for each of the four cups are illustrated. As shown, cups A, B, C, and D can hold 5, 6, 7, and 9 balls, respectively. For the purpose of this illustration, cups A through D are open cups that are empty.

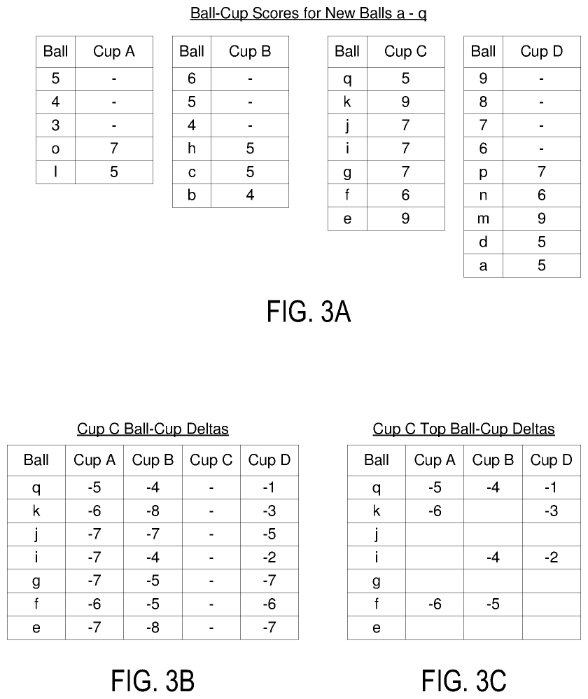

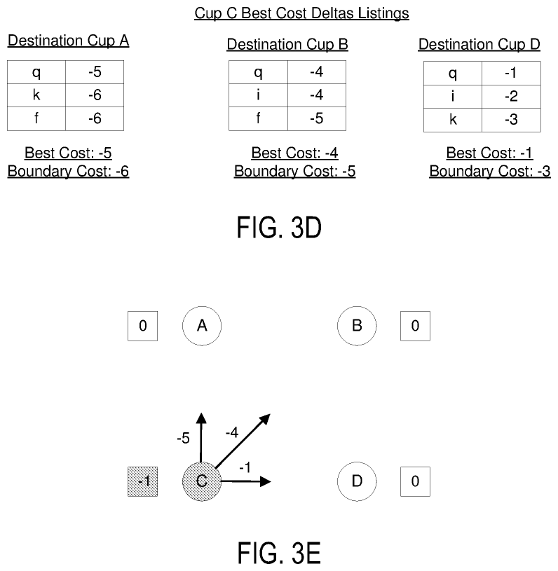

Referring now to FIGS. 3A-3E, new balls a through q have been received. Because none of the cups are filled prior to receiving ball q, each ball through ball p has been assigned to its preferred cup, the cup corresponding to the highest cup-score for the ball as shown in FIG. 3A. When ball q is received, it is assigned to cup C (its preferred cup), causing it to reach its capacity and transition to being a full cup. Because it has become a full cup, listings of the best cost deltas for each ball in cup C may be created based on differences, i.e., deltas, between ball-cup scores of cup C and cups A, B, and D.

As shown in FIG. 3B, a table presenting deltas between cup C and the other cups is shown, where each ball in cup C has one delta corresponding to one cup. For instance, ball q has a ball-cup score of 5 for cup C from which deltas of −5, −4, and −1 corresponding to cups A, B, and D, respectively, have been computed based upon the respective ball-cup scores of 0, 1, and 4 shown in FIG. 2A. If ball q is transferred to cup A, it would lose a ball-cup score of −5; likewise, if transferred to cups B and D, ball q would lose ball-cup scores of −4 and −1, respectively.

Once all of the deltas for cup C have been determined, not all of them are necessary as disclosed herein. In some embodiments, a user may limit the number of deltas that are tracked to the N highest deltas, where N is less than the capacity of cup C.

In situations which involve millions of customers or subscribers (each represented by a ball) and hundreds or thousands of products (each represented by a cup) from which combinations of products may be tailored for each individual subscriber, a limitation placed upon the number of tracked deltas may result in a significant reduction in the amount of processing or computation time due of a reduction of the number of computations being performed.

For the purpose of illustration and not of limitation, the number of deltas will be limited to the three deltas having the greatest values for each corresponding cup, i.e., the top three deltas. Referring to FIG. 3C, a table presenting the top three deltas between cup C and the other cups is shown.

As shown in FIG. 3D, listings of the best cost deltas from cup C to the other cups based on the top three deltas may be created through a numerical sort to list the top three best costs in a descending order. As shown, best costs corresponding to now-destination cups A, B, and D are −5, −4, and −1, respectively, and boundary costs corresponding destination cups A, B, and D are −6, −5, and −3, respectively.

As shown in FIG. 3E, a graphical representation of the best costs from cup C is presented in the form of a directed graph having nodes (represented by circles) and edges (represented by arrows) where cups are represented by nodes and best costs are represented by edges. As illustrated, cup C is represented as node C, and the best costs −5, −4, and −1 of cup C are represented as outgoing edges of the directed graph directed to nodes A, B, and D, respectively, representing respective cups A, B, and D. For the purpose of illustration, node C is a circle that is shaded to represent a full cup, whereas nodes A, B, and D are not shaded to represent open cups. Also, nodes are not illustrated with incoming edges arriving to them (i.e., the tips of the arrows representing edges do not intersect the nodes to which they are directed); however, each outgoing edge becomes an incoming edge at the node to which it is directed. For example, nodes A, B, and D implicitly include incoming edges of −5, −4, and −1, respectively.

Once the best costs have been determined, a best move path to achieve the lowest cost of the system may be determined. Because each cup other than cup C is open, the best move for cup C is to the open cup D as it will suffer the least cost of −1. The least cost of −1 to cup C is shown in the graphical representation as the shaded square next to node C; the unshaded squares with zeros next to nodes A, B, and D indicate that best path costs have not been computed for cups A, B, and D, respectively. Because cups A, B, and D are open cups that have not reached capacity, new balls may be added directly to them without the need to move a ball that is already in the cup.

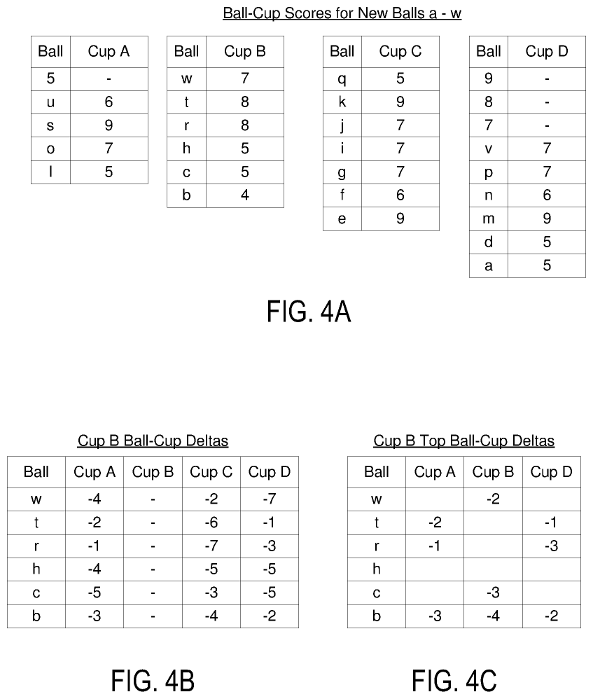

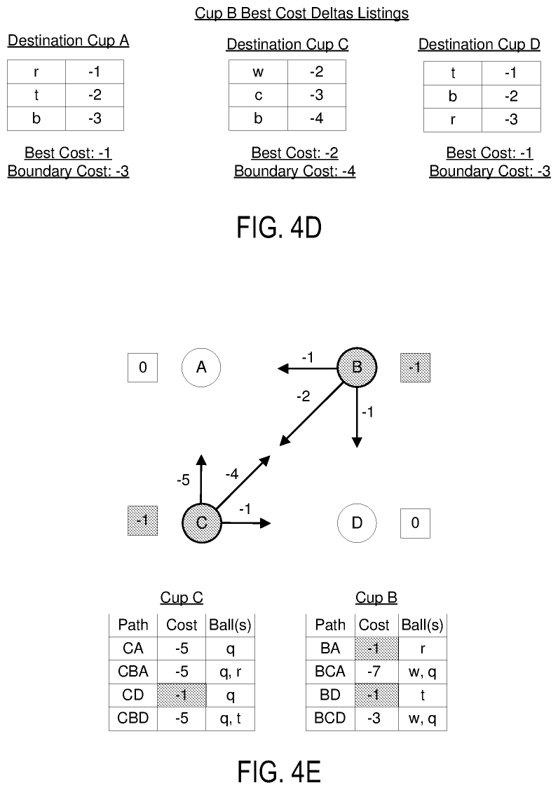

Referring now to FIGS. 4A-4E, new balls a through v have already been received. As shown in FIG. 4A, balls a through v have been assigned to the cup corresponding to its highest cup-score. When ball w is added to its preferred cup, cup B reaches its capacity and transitions to being a full cup.

As shown in FIG. 4B, a table presenting deltas between cup B and the other cups is shown, where each ball in cup B has one delta corresponding to one cup. As shown in FIG. 4C, a table presenting top three deltas between cup B and the other cups is shown.

As shown in FIG. 4D, listings of the best cost deltas from cup B to the other cups may be created similar to the listings of cup C. As shown, the best costs corresponding to destination cups A, C, and D are −1, −2, and −1, respectively, and the boundary costs corresponding destination cups A, C, and D are −3, −4, and −3, respectively.

As shown in FIG. 4E, a graphical representation of the best costs for cups C and B are presented along with tables providing path, cost, and ball transfer information for the cups. As illustrated, full cup B is represented as a shaded node B, and the best costs −1, −2, and −1 are represented as outgoing edges that are directed to nodes A, C, and D, respectively, representing respective cups A, C, and D.

Because there is more than one full cup, there is more than one path to an open cup, where each path could have different costs. For instance, there are two paths between full cup C and open cup A: a direct path CA or indirect path CBA; for the purpose of brevity and since paths connect cups, paths will be identified from the nodes being connected. The cost for traveling along paths CA and CBA are −5 and −5 (−4+(−1)), respectively. Reviewing the best costs of FIGS. 3D and 4D, path CA would require ball q to transfer to cup A. Path CBA would require two balls to be transferred: ball q to cup B along path CB, and ball r to cup A along path BA.

As shown in FIG. 4E, there are also two paths between full cup C and open cup D shown: path CD at a cost of −1, and path CBD at a cost of −5 (−4+(−1)). From the best costs, ball q would transfer to cup D along path CD; for path CBD, ball q would transfer to cup B, and ball t to cup D.

Similarly, there are two paths between full cup B and open cup A: path BA at a cost of −1, and path BCA at a cost of −7. Ball r would transfer to cup A along path BA; for path BCA, ball w would transfer to cup C, and ball q to cup D.

Likewise, there are two paths between full cup B and open cup D: path BD at a cost of −1, and path BCD at a cost of −3. Ball t would transfer to cup D along path BD; for path BCD, ball w would transfer to cup C, and ball q to cup D.

By comparing the cup C costs of −5 (CA), −5 (CBA), −1 (CD), and −5 (CBD), the best path to an open cup for full cup C is CD because it suffers the least cost; hence, the best path cost for cup C is −1. Likewise, for the cup B costs of −1 (BA), −7 (BCA), −1 (BD), and −3 (BCD), the best path to an open cup may be either BA or BD because each suffers the least cost; that is, the best path cost for cup B of −1. The best path costs are represented in the shaded squares next to their respective nodes and shaded cells in the table.

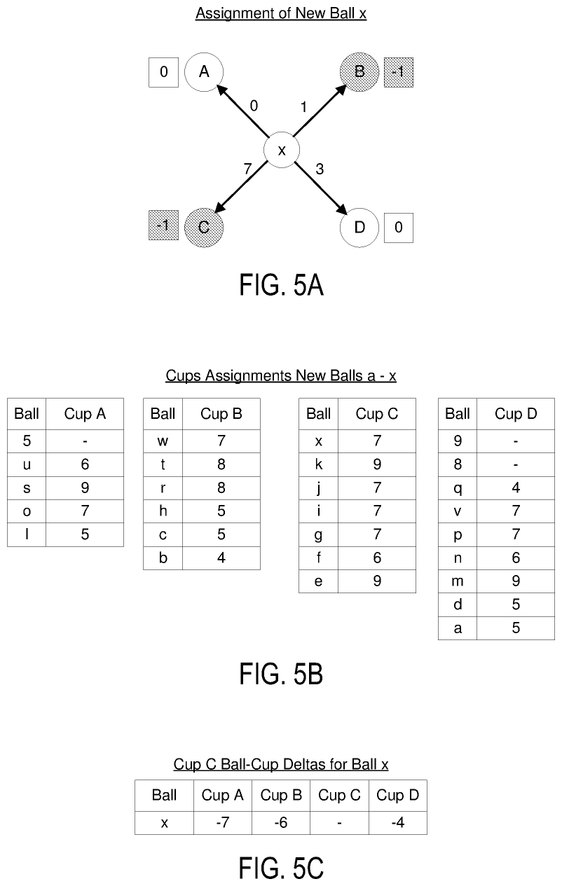

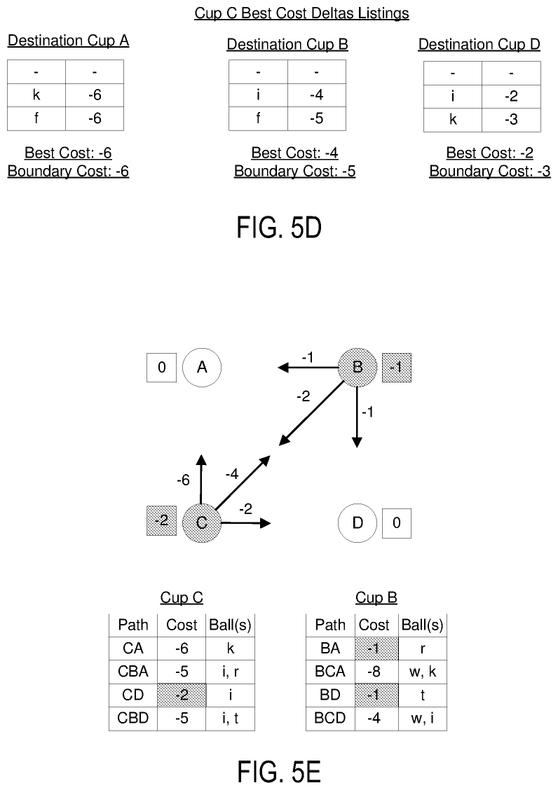

Referring now to FIG. 5A-5E, new ball x with ball-cups scores 0, 1, 7, and 3 for cups A, B, C, and D, respectively, has been received and is ready for assignment. The greatest ball-cup score is 7 for its preferred cup C which is a full cup. In this case, the ball assignment will be computed as the cup that yields the largest computed sum of the ball-cup score and the best path cost for each cup.

As shown in FIG. 5A, cup A yields 0 (0+0), cup B yields 0 (1+(−1)), cup C yields 6 (7+(−1)), and cup D yields 3 (3+0)). Here, new ball x will be assigned cup C because it is the cup that has yielded the largest computed sum of 6. Because cup C is a full cup, one of the balls in cup C will have to be reassigned (i.e., transferred) to a new destination cup to facilitate the assignment of new ball x. This may be determined from the best path cost and best path information that has been determined for cup C. Referring back to the table for cup C in FIG. 4E, ball q will be reassigned from its preferred cup to destination cup D of best path CD at a best path cost of −1.

As shown in FIG. 5B, the assignment of new ball w to cup C and the reassignment of ball q to cup D are presented. As observed, ball q is now the seventh ball in open cup D with a ball-cup of 4 which takes into account the best path cost of −1 from its ball-cup score of 5 for cup C. New ball x with its ball-cup score of 7 for cup C has taken its place in cup C.

Because ball q has been reassigned, the best costs shown in FIG. 3D for cup C need to be visited and updated to account for the reassignment of ball q and to keep current the best costs effected by the reassignment. This includes a determination of whether one or more of the ball x deltas of cup C need to be added to one or more best cost deltas listings by comparing them with the boundary costs shown in FIG. 3D.

As shown in FIG. 5C, a table presenting ball x deltas of −7, −6, and −4 are presented for cups A, B, and D, respectively. Since these scores are not greater than or equal to their respective boundary costs of −6, −5, and −3, the ball x deltas are not added to the listings.

As shown in FIG. 5D, ball q has been removed from the listing for its destination cup D. Because ball q no longer appears in cup C, it has been removed from the listings for cups A and B. The best cost deltas shown in FIG. 5D are now the current best cost deltas for cup C.

As shown in FIG. 5E, a graphical representation of the current best costs for cups C and B are presented along with tables providing path, cost, and ball transfer information for the cups. The best path and best path cost may be determined using the same methodology as discussed above. By comparing the cup C costs of −6 (CA), −5 (CBA), −2 (CD), and −5 (CBD), the best path to an open cup is CD because it suffers the least cost; hence, the best path cost for cup C is −2; likewise, by comparing the cup B costs of −1 (BA), −8 (BCA), −1 (BD), and −4 (BCD), the best path to an open cup may be either BA or BD because each suffers the least cost; that is, the best path cost for cup B of −1.

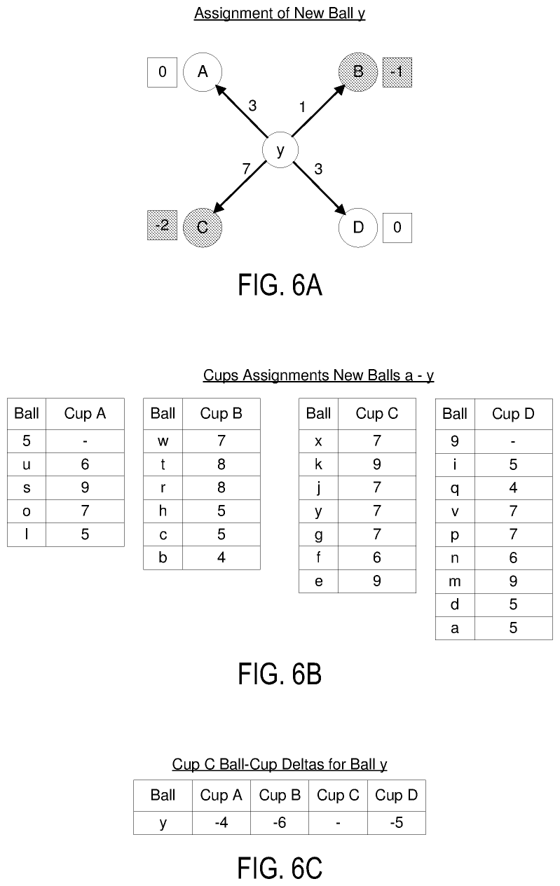

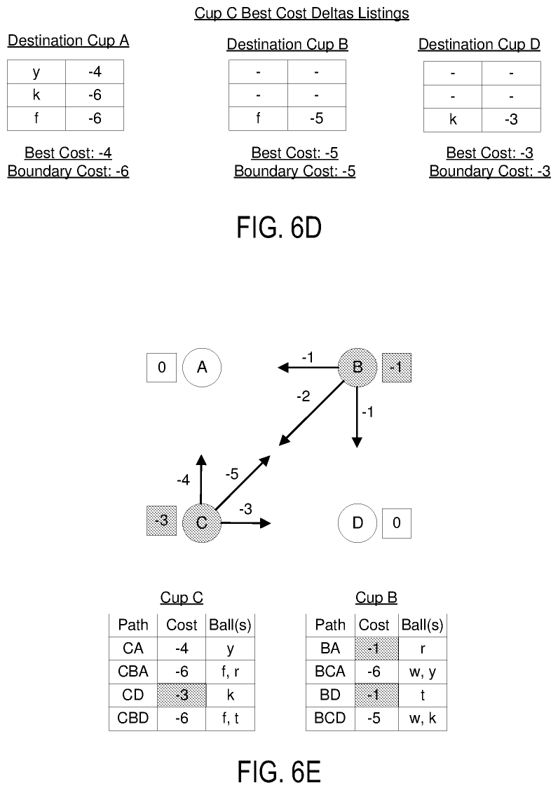

Referring now to FIG. 6A-6E, new ball y with ball-cup scores 3, 1, 7, and 3 for cups A, B, C, and D, respectively, has been received and is ready for assignment. The greatest ball-cup score is 7 for cup C which is a full cup. As stated above, the ball assignment could be computed as the cup that yields the largest computed sum of the ball-cup score and the best path cost for each cup.

As shown in FIG. 6A, cup A yields 3 (3+0), cup B yields 0 (1+(−1)), cup C yields 5 (7+(−2)), and cup D yields 3 (3+0)). Here, new ball y will be assigned cup C because it is the cup that has yielded the largest computed sum of 5. Because cup C is a full cup, one of the balls in cup C will have to be reassigned to a new destination cup to facilitate the assignment of new ball y. Referring back to the table for cup C in FIG. 5E, ball i will be reassigned from its preferred cup to destination D of best path CD at a best path cost of −2.

As shown in FIG. 6B, the assignment of new ball y to cup C and the reassignment of ball i to cup D are presented. As observed, ball i is now the eighth ball in open cup D with a ball-cup score of 5 which takes into account the best path cost of −2 from its cup C ball-cup score of 7. New ball y with its ball-cup score of 7 has taken its place in cup C.

Because ball i has been reassigned, the best costs shown in FIG. 5D for cup C need to be visited and updated to account for the reassignment of ball i and to keep current the best costs effected by the reassignment. Also, it needs to be determined whether one or more of the ball y deltas of cup C need to be added to one or more of the best cost deltas listings by comparing them with the boundary costs shown in FIG. 5D.

As shown in FIG. 6C, a table presenting ball y ball-cup score deltas of −4, −6, and −4 are presented for cups A, B, and D, respectively. Since the deltas for cups B and D are not greater than or equal to their respective boundary costs of −5 and −3 as shown in FIG. 5D, the ball y deltas are not added to their respective listings; however, since the cup A delta is greater than its respective boundary cost of −6, the delta of −4 for ball y for cup A is added to the listing for cup A as shown in FIG. 6D.

Also, ball i has been removed from the listing for destination cup D. Because ball i no longer appears in cup C, it has been removed from the listing for cup B; the listing for cup A is not affected because ball i did not appear on it. The best costs shown in the listings of FIG. 6D are now the current best costs for cup C.

As shown in FIG. 6E, a graphical representation of the current best costs for cups C and B are presented along with tables providing path, cost, and ball transfer information for the cups. The best path and best path cost may be determined using the same methodology as discussed above. By comparing the cup C costs of −4 (CA), −6 (CBA), −3 (CD), and −6 (CBD), the best path for full cup C is CD because it suffers the least cost; hence, the best path cost for cup C is −3; likewise, by comparing the cup B costs of −1 (BA), −6 (BCA), −1 (BD), and −5 (BCD), the best path to an open cup may be either BA or BD because each suffers the least cost; that is, the best path cost for cup B of −1.

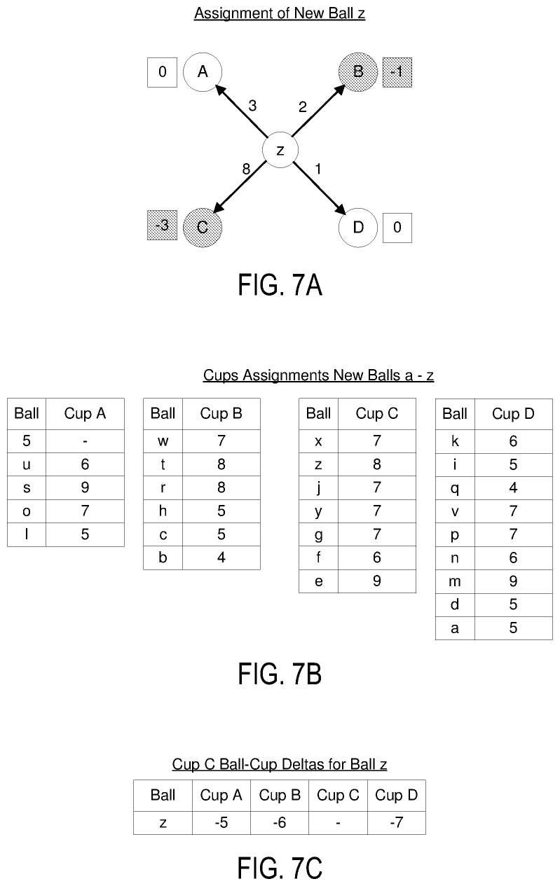

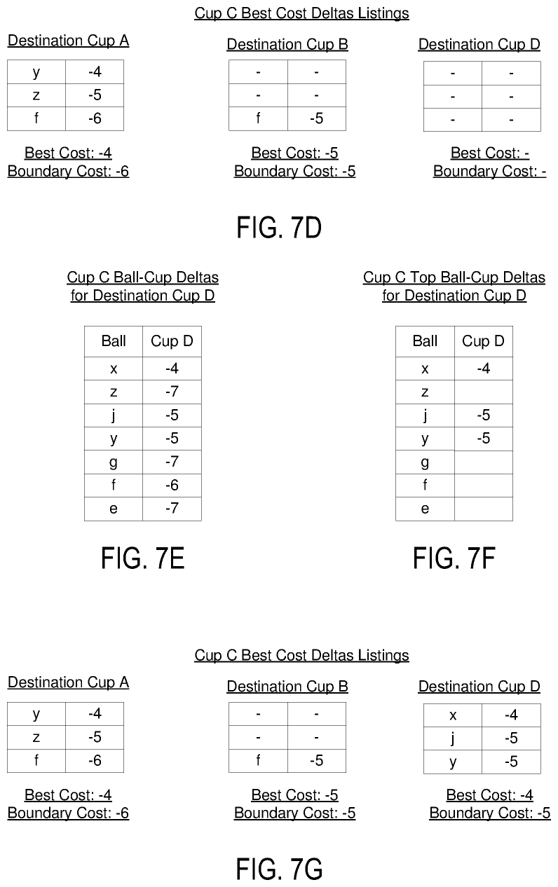

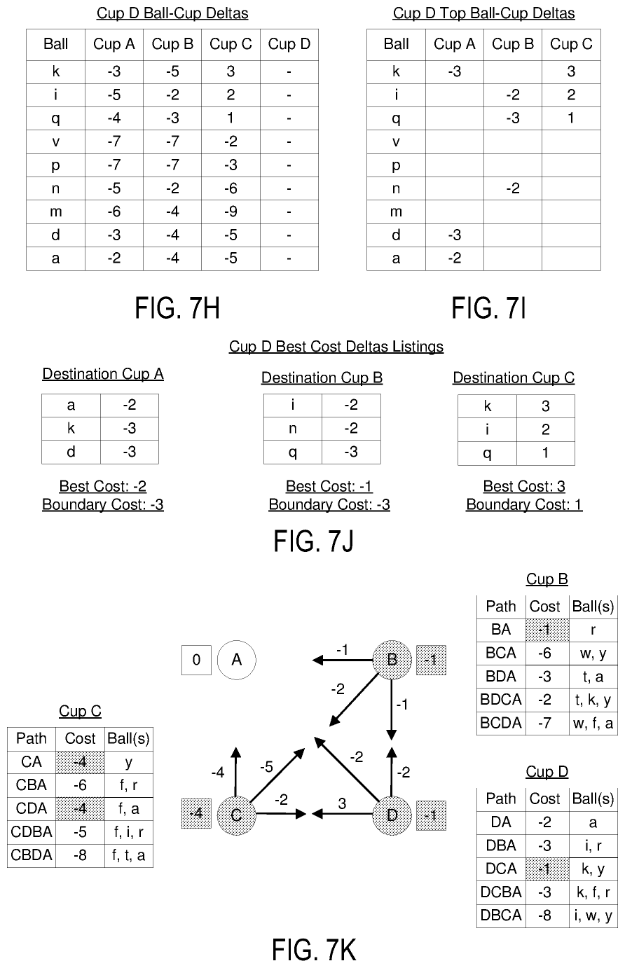

Referring now to FIG. 7A-7E, new ball z with ball-cups scores 3, 2, 8, and 1 for cups A, B, C, and D, respectively, has been received and is ready for assignment. The greatest ball-cup score is 8 for cup C which is a full cup. As stated above, the ball assignment could be computed as the cup that yields the largest computed sum of the ball-cup score and the best path cost for each cup.

As shown in FIG. 7A, cup A yields 3 (3+0), cup B yields 1 (2+(−1)), cup C yields 5 (8+(−3)), and cup D yields 1 (1+0)). Here, new ball z will be assigned cup C because it is the cup that has yielded the largest computed sum of 5. Because cup C is a full cup, one of the balls in cup C will have to be reassigned to a new destination cup to facilitate the assignment of new ball z. Referring back to the table for cup C in FIG. 6E, ball k will be reassigned from its preferred cup to destination D of best path CD at a best path cost of −3.

As shown in FIG. 7B, the assignment of new ball z to cup C and the reassignment of ball k to cup D are presented. As observed, ball k is now the ninth ball in cup D with a ball-cup score of 6 which takes into account the best path cost of −3 from its cup C ball-cup score of 9. When ball k is added, cup D reaches its capacity and transitions to being a full cup. New ball z with its ball-cup score of 8 has taken its place in cup C.

Because ball k has been reassigned, the best costs shown in FIG. 6D for cup C need to be visited and updated to account for the reassignment of ball k and to keep current the best costs effected by the reassignment. Also, it needs to be determined whether one or more of the ball k deltas of cup C need to be added to one or more of the listings by comparing them with the boundary costs shown in FIG. 6D.

As shown in FIG. 7C, a table presenting ball z ball-cup score deltas of −5, −6, and −7 are presented for cups A, B, and D, respectively. Since the ball-cup score deltas for cups B and D are not greater than or equal to their respective boundary costs of −5 and −3 as shown in FIG. 6D, the ball z ball-cup score deltas are not added to their respective listings; however, since the cup A ball-cup score delta is greater than its respective boundary cost of −6, the ball-cup score delta of −5 for ball z for cup A is added to the best cost deltas listing for cup A as shown in FIG. 7D.

Also, ball k has been removed from the listing for its destination cup D. Because ball k no longer appears in cup C, it has been removed from the listing for cup A; the listing for cup B is not affected because ball k did not appear on it.

As observed, the listing for destination cup D of cup C no longer has deltas. As such, a new listing needs to be generated for destination cup D using the cup C current ball-cup scores shown in FIG. 7B and corresponding ball-cup scores shown in FIG. 2A. From these scores, the deltas for destination cup D of cup C have been determined and are presented in FIG. 7E; the top three of these are presented in FIG. 7F. With the information, the best cost deltas listings and the current best costs for cup C are presented in FIG. 7G.

Because cup D has transitioned into being a full cup, best costs for cups A, B, and C need to be established using the cup D current ball-cup scores shown in FIG. 7B and corresponding ball-cup scores shown in FIG. 2A. Applying the same methodology as discussed above, the ball-cup score deltas of cup D have been determined and are presented in FIG. 7H; the top three of these are presented in FIG. 7I. With this information, the best cost deltas listings and the current best costs for cup D have been established and are presented in FIG. 7J.

As shown in FIG. 7K, a graphical representation of the current best costs for cups C, B, and D are presented along with tables providing path, cost, and ball transfer information for the cups. The best path and best path cost to open cup A may be determined using the same methodology as discussed above. By comparing the cup C costs of −4 (CA), −6 (CBA), −4 (CDA), −5 (CDBA), and −8 (CBDA) in FIG. 7K, the best path for full cup C is either CA or CDA because each suffers the least cost; that is, the best path cost for cup C of −4. By comparing the cup B costs of −1 (BA), −6 (BCA), −3 (BDA), −2 (BDCA), and −7 (BCDA), the best path for cup B is BA because it suffers the least cost; that is, the best path cost for cup B of −1. By comparing the cup D costs of −2 (DA), −3 (DBA), −1 (DCA), −3 (DCBA), and −8 (DBCA), the best path for cup D is DCA because it suffers the least cost; that is, the best path cost for cup D of −1.

It should be noted that the determination of the best path cost could result in one or more zeros or positive numbers. In such instances, the best path cost for the cup would be the maximum value(s) resulting from the determination.

As observed from the preceding discussion, there are fifteen possible paths to one open cup in a four cup system in which there is one open cup and three full cups. Also, besides one direct path to the open cup from each of the other full cups, there are four indirect paths for which each requires a summation of more than one cost. Although these determinations may be manageable and not unbearable when performed manually in a system of a relatively few numbers of cups, a system which employs tens, hundreds, or more cups within a system is simply not manageable and unbearable.

In some embodiments, the best path is determined as a function of the Floyd-Warshall all-pairs shortest distance algorithm employing three nested loops adapted for use with best-path score deltas instead of distances, where an outer loop of the algorithm is comprised of nodes with both outgoing and incoming edges, a middle loop of the algorithm is comprised of nodes with outgoing edges, and an inner loop is comprised of nodes with incoming edges

As discussed above, a directed graph has been employed in the determination for the best path cost for each full cup. Although typically employed to find shortest paths, shortest distance algorithms may be employed to determine best path costs. For example, the Floyd-Warshall all-pairs minimum distance algorithm may be modified to form a Floyd-Warshall minimum path cost. Instead of the algorithm's use of positive and negative edge lengths (or weights) between vertices, the costs of outgoing and incoming edges, respectively, between nodes may be used. Instead of finding shortest paths in a single execution using path length as weights in the directed graph (i.e., a direct weighted graph), minimum path costs may be found in a single execution using path costs as weights.

For example, the Floyd-Warshall algorithm employs three nested loops adapted for use with best costs. The outer loop of the algorithm may be comprised of nodes with both outgoing and incoming edges, a middle loop of the algorithm may be comprised of nodes with outgoing edges, and an inner loop may be comprised of nodes with incoming edges. As applied to the directed graph of FIG. 7K, an inner loop may be comprised of node A with incoming edges with costs of −1, −4, and −2 from nodes B, C, and D, respectively.

A middle loop may be comprised of nodes B, C, and D with outgoing edges. Node B may be a node with outgoing edges with costs of −1, −2, and −1 to nodes A, C, and D, respectively. Node C may be a node with outgoing edges with costs of −4, −5, and −2 to nodes A, B, and D, respectively. Node D may be a node with outgoing edges with costs of −2, −2 and 3, to nodes A, B, and D, respectively.

Alternatively, an outer loop may be comprised of nodes B, C, and D with both outgoing and incoming edges. Node B may be a node with not only outgoing edges with costs of −1, −2, and −1 to nodes A, C, and D, respectively, but also with incoming edges with costs of −5 and 2- from Nodes C and D, respectively. Node C may be a node with not only outgoing edges with costs of −4, −5, and −2 to nodes A, B, and D, respectively, but also with incoming edges with costs of −2 and 3 from Nodes B and D, respectively. Node D may be a node with not only outgoing edges with costs of −2, −2, and 3 to nodes A, B, and C, respectively, but also with incoming edges with costs of −1 and −2 from Nodes B and C, respectively.

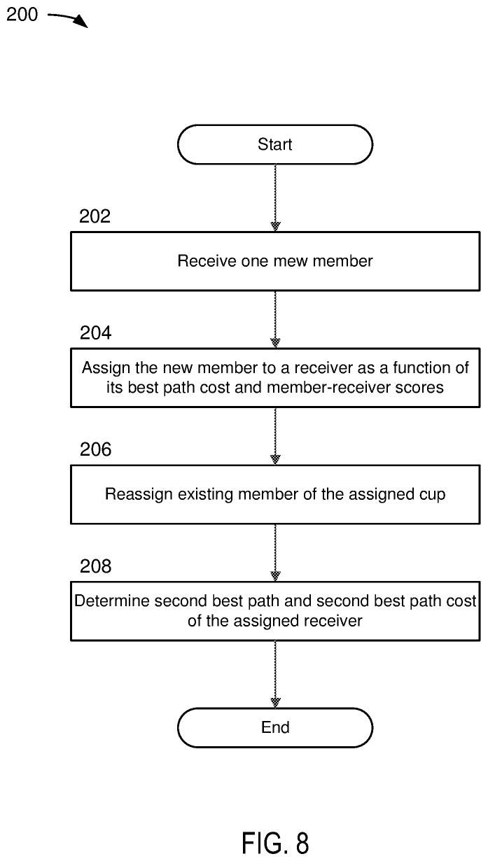

FIG. 8 depicts flowchart 200 disclosing an example of a method for assigning a new member of a sequence of new members to one receiver of a plurality of receivers in dynamic distributional system 100.

The method of flowchart 200 begins with module 202 with the system receiving one new member having at least one member-receiver score, where each member-receiver score is a score corresponding to one receiver. In some embodiments, each new member may have a preferred receiver and one or more alternative receivers, where the preferred receiver corresponds to the one member-receiver score that is higher or greater than the other member-receiver score(s). In some embodiments, the new member is assigned to its preferred receiver if it is an open receiver.

The method of flowchart 200 continues with module 204 with the system assigning the new member to a receiver as a function of the new member's member-receiver score corresponding to the receiver and its best path cost. In some embodiments, the receiver yielding the largest computed sum of a receiver's member-receiver score and its best path cost will be the assigned receiver. In some embodiments, the best path cost for an open receiver is zero.

The method of flowchart 200 continues with module 206 with the system reassigning an existing member in the assigned receiver to a destination receiver if the assigned receiver is determined to be a full receiver, where the destination receiver may be determined as a function of at least the first best path of the assigned receiver.

The method of flowchart 200 continues with module 208 with the system determining a second best path and a second best path cost of the assigned receiver in response to the assignment and reassignment. Once determined, the system is now ready to return to module 202 and use the second best path cost to assign the next new member as a function in a continuous loop of modules 202-208 for a series of new members. Then, the method of flowchart 200 ends.

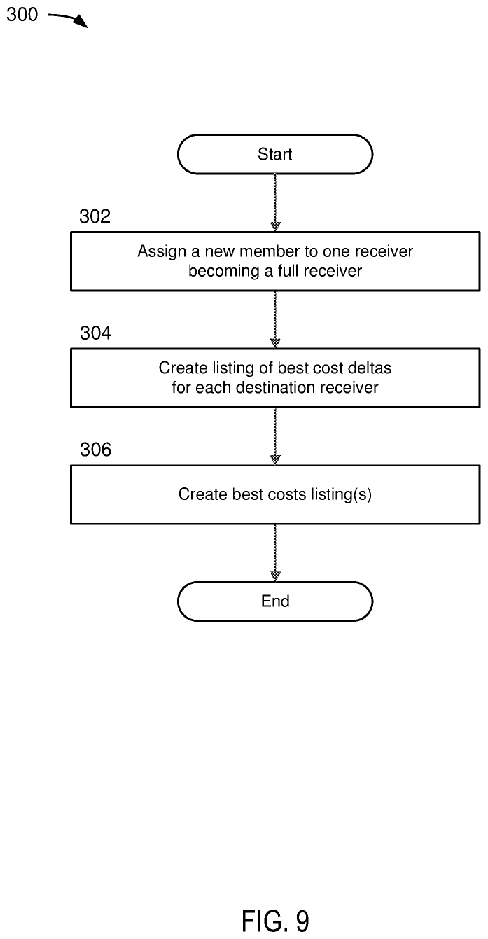

FIG. 9 depicts flowchart 300 disclosing an example of a method for determining a best path between two receivers in a system of a plurality of receivers in dynamic distributional system 100.

The method of flowchart 300 begins with module 302 with the system assigning a new member to one receiver that, as a result of the assignment, transitions from being an open receiver to being a full receiver.

The method of flowchart 300 continues with module 304 with the system creating a listing of best cost deltas and corresponding members for each destination receiver, where such listing may be created as a function of the plurality of member-receiver scores of the new member. In some embodiments, each destination receiver may be either an open or full destination receiver. Each cost delta may be the difference between the member-receiver score of the new member corresponding to the assigned receiver and a member-receiver score corresponding to one destination receiver. In some embodiments, each listing includes fewer members than the assigned receiver's member capacity. In some embodiments, each listing may include a best cost for each destination receiver. In some embodiments, each listing may include a boundary cost.

The method of flowchart 300 continues with module 306 with the system determining a best path and a best path cost of the assigned receiver as a function of the best cost of each listing of the assigned receiver and a best cost of one or more listings of each full destination receiver that were determined prior to the assignment of the new member. Once determined, the system is now ready to use the best path cost determined for the assigned receiver in the assignment of the next new member. Also, the best path to an open cup may be comprised of the best path. Then, the method of flowchart 300 ends.

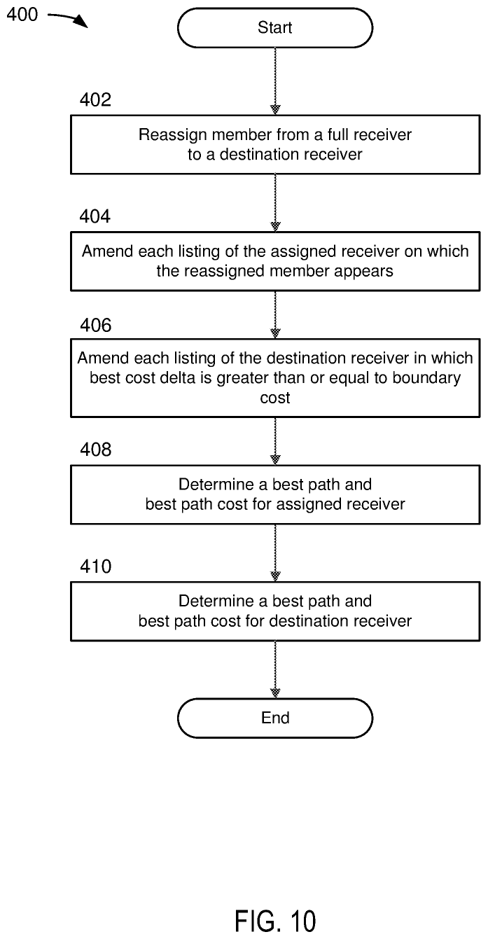

FIG. 10 depicts flowchart 400 disclosing an example of a method for monitoring a receiver reassignment of a member in a system of a plurality of receivers in dynamic distributional system 100.

The method of flowchart 400 begins with module 402 with the system reassigning a member from a full receiver to a destination receiver of one or more destination receivers in response to an assignment of a new member to the full receiver, i.e., assigned receiver. In some embodiments, the assignment may have been determined as a function of a previously determined best path cost of the assigned receiver, and the reassignment may be determined as a function of a previously determined best path of the assigned receiver. In some embodiments, a best path may have been determined from listings of the assigned receiver that includes best cost deltas and corresponding member and a plurality of listings of best cost deltas for the destination receiver(s).

The method of flowchart 400 continues with module 404 with the system amending one or more listings of the assigned receiver. In some embodiments, one or more listings may be amended by removing its best cost. In some embodiments, one or more listings may be amended by removing the reassigned member and corresponding best cost delta from each listing on which the reassigned member is listed. In some embodiments, one or more replacement listings may be created when its boundary cost(s) corresponding to a best cost delta is removed.

The method of flowchart 400 continues with module 406 with the system amending one or more listings of the destination receiver. In some embodiments, one or more listings may be amended when a best cost delta of the reassigned member corresponding to the destination receiver is greater than or equal to a boundary cost of the listing.

The method of flowchart 400 continues with module 408 with the system determining, for the assigned receiver, a best path to an open receiver and a best path.

The method of flowchart 400 continues with module 408 with the system determining, for the assigned receiver, a second best path to an open receiver and a second best path.

The method of flowchart 400 continues with module 406 with the system amending one or more listings of the destination receiver, if any, in which a best cost delta of the reassigned member corresponding to the destination receiver is greater than or equal to a boundary cost of the listing.

The method of flowchart 400 continues with module 408 with the system determining, for the assigned receiver, a best path to an open receiver and a best path cost.

The method of flowchart 400 continues with module 410 with the system determining, for the destination receiver, a best path to an open receiver and a best path cost. Once determined, the system is now ready to use the best path costs of both the assigned receiver and destination receiver in the assignment of the next new member. Then, the method of flowchart 400 ends.

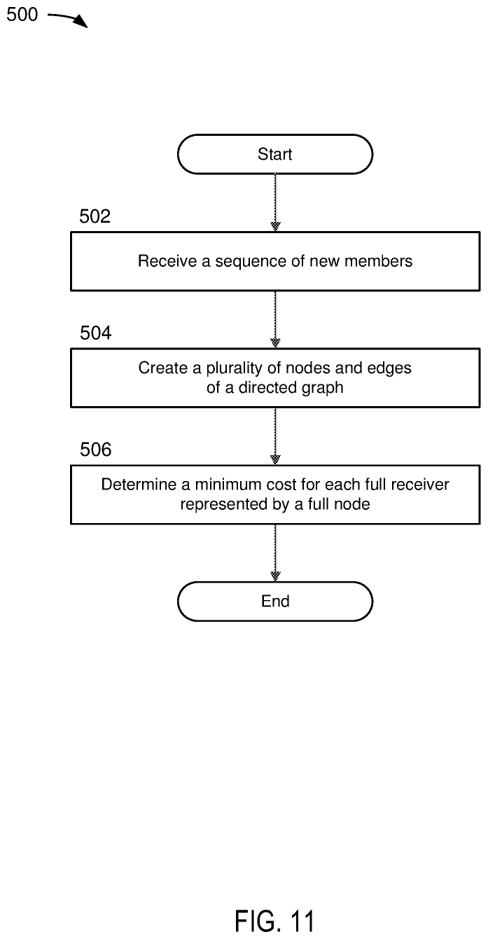

FIG. 11 depicts flowchart 500 disclosing an example of a method for determining minimum costs for a plurality of receivers in an assignment system receiving a sequence of new members.

The method of flowchart 500 begins with module 502 with the APU 110 receiving data representative of a sequence of new members to the assignment system. In some embodiments, each new member may have a preferred receiver and one or more alternative receivers, where the preferred receiver corresponds to the one member-receiver score that is higher or greater than the other member-receiver score(s). In some embodiments, the new member is assigned to its preferred receiver if it is an open receiver.

The method of flowchart 500 continues with module 504 with the APU 110 creating a plurality of nodes and a plurality of edges of a directed graph, where each node may represent a receiver, each edge may represent a cost between two receivers, each receiver may be an open receiver or a full receiver, each open receiver may be comprised of a plurality of incoming edges, and/or each full receiver is comprised of at least a plurality of outgoing edges. In some embodiments, each incoming edge may be one outgoing edge directed from one full receiver, and/or each outgoing edge of each full receiver may be directed to one open receiver or one full receiver.

The method of flowchart 500 continues with module 506 determining a minimum cost for each full receiver as a function of the cost of each outgoing edge comprising the full receiver. In some embodiments, the function could be the Floyd-Warshall algorithm adapted for minimum costs. Then, the method of flowchart 500 ends.

It should be noted that the steps of the method described above may be embodied in computer-readable media stored in a non-transitory computer-readable medium as computer instruction code. The method may include one or more of the steps described herein, which one or more steps may be carried out in any desired order including being carried out simultaneously with one another. For example, two or more of the steps disclosed herein may be combined in a single step and/or one or more of the steps may be carried out as two or more sub-steps. Further, steps not expressly disclosed or inherently present herein may be interspersed with or added to the steps described herein, or may be substituted for one or more of the steps described herein as will be appreciated by a person of ordinary skill in the art having the benefit of the instant disclosure.

As used herein, the term “embodiment” means an embodiment that serves to illustrate by way of example but not limitation.

It will be appreciated to those skilled in the art that the preceding examples and embodiments are exemplary and not limiting to the broad scope of the inventive concepts disclosed herein. It is intended that all modifications, permutations, enhancements, equivalents, and improvements thereto that are apparent to those skilled in the art upon a reading of the specification and a study of the drawings are included within the broad scope of the inventive concepts disclosed herein. It is therefore intended that the following appended claims include all such modifications, permutations, enhancements, equivalents, and improvements falling within the broad scope of the inventive concepts disclosed herein.

What is claimed is:

1. A method for assigning a new member to a full receiver in a dynamic distributional system having a plurality of receivers, comprising:
receiving, by a processing unit including at least one processor coupled to a non-transitory processor-readable medium storing processor-executable code, data representative of a new member having a plurality of member-receiver scores, where
each member-receiver score corresponds to one receiver, and
the new member has a preferred receiver;
assigning the new member to a receiver as a function of a first best path cost for each full receiver and its corresponding member-receiver score of the new member;
reassigning an existing member in the assigned receiver to a destination receiver as a function of at least the first best path of the assigned receiver when the assigned receiver is determined to be a full receiver; and
determining a second best path and a second best path cost of the assigned receiver in response to the assignment and the reassignment, whereupon
the second best path and the second best path cost is provided to a new member module of the processing unit for use in the assignment of the next new member.

2. The method of claim 1, wherein each new member and its member-receiver score is unknown prior to the new member being received into the system.

3. The method of claim 1, wherein the preferred receiver has a member-receiver score greater than the other member-scores of the new member.

4. The method of claim 1, wherein the new member is assigned to its preferred receiver when it is an open receiver.

5. The method of claim 1, wherein the assigned receiver is the receiver yielding the largest computed sum of its first best path and its corresponding member-receiver score of the new member.

6. A method for determining a best path between two receivers in a system having a plurality of receivers, comprising:
assigning, by a processing unit including at least one processor coupled to a non-transitory processor-readable medium storing processor-executable code, data representative of a new member to one receiver, such that
the assigned receiver transitions to being a full receiver as a result of the assignment, where
the new member has a plurality of member-receiver scores, and
each member-receiver score corresponds to one receiver;
creating a listing of best cost deltas and corresponding members for each destination receiver as a function of the plurality of member-receiver scores of the new member, where
each destination receiver is a receiver other than the assigned receiver,
each destination receiver is either an open or full destination receiver,
each listing includes fewer members than the assigned receiver's member capacity, and
each listing includes a first best cost for each destination receiver; and
determining a best path and a best path cost of the assigned receiver as a function of the first best cost of each listing and a second best cost of at least one listing of each full destination receiver determined prior to the assignment of the new member, whereupon
the best path cost is provided to a new member module of the processing unit for use in the assignment of the next new member, and
the best path comprises a best path to an open cup.

7. The method of claim 6, wherein the function for creating the listing of best cost deltas includes determining, for each destination receiver, a difference between the member-receiver score of the new member corresponding to the assigned receiver and the member-receiver score of the corresponding receiver.

8. The method of claim 6, wherein the listing for each destination receiver and the at least one listing of each full destination receiver includes a boundary cost.

9. A method for monitoring a receiver reassignment of a member in a dynamic distributional system having a plurality of receivers, comprising:
reassigning, by a processing unit including at least one processor coupled to a non-transitory processor-readable medium storing processor-executable code, data representative of a member from one full receiver to a destination receiver of a plurality of destination receivers in response to an assignment of a new member to the one full receiver, such that
the one full receiver in an assigned receiver;
amending at least one listing of the assigned receiver;
amending each listing of the destination receiver on which a best cost delta of the reassigned member corresponding to the destination receiver is greater than or equal to a boundary cost of the listing of the destination receiver;
determining, for the assigned receiver, a first best path to an open receiver and a first best path; and
determining, for the destination receiver, a second best path to an open receiver and a second best path cost, whereupon
the second best path cost and the third best path cost is provided to a new member module of the processing unit for use in the assignment of the next new member.

10. The method of claim 9, wherein at least one listing of the assigned receiver is amended by removing a best cost from the listing.

11. The method of claim 9, wherein at least one listing of the assigned receiver is amended by removing the reassigned member and corresponding best cost delta from each listing on which the reassigned member is listed.

12. The method of claim 9, wherein the listing for each assigned receiver includes a boundary cost.

13. The method of claim 9, further comprising:
creating a replacement listing of the assigned receiver for each listing from which a boundary cost corresponding to a best cost delta of the reassigned member is removed.

14. The method of claim 9, wherein a best cost delta of the reassigned member corresponding to the destination receiver is equal to the difference between a member-receiver score of the reassigned member corresponding to the assigned receiver and a member-receiver score of the reassigned member corresponding to the destination receiver.

15. An assignment device of a dynamic distributional system, comprising:
a processing unit including at least one processor coupled to a non-transitory processor-readable medium storing processor-executable code, configured to:
receive data representative of a sequence of new members;
create a plurality of nodes and a plurality of edges of a directed graph, where each node represents a receiver,
each edge represents of a cost between two receivers,
each receiver is an open receiver or a full receiver,
each open receiver is comprised of plurality of incoming edges, and
each full receiver is comprised of at least a plurality of outgoing edges, where
each incoming edge is one outgoing edge directed from one full receiver, and
each outgoing edge of each full receiver is directed to one open receiver or one full receiver; and
determine a minimum cost for each full receiver as a function of the cost of each outgoing edge comprising the full receiver, whereupon
the minimum cost for each full receiver is provided to a new member module of the processing unit for use in the assignment of the next new member.

16. The assignment device of claim 15, wherein the function for determining the minimum cost for each full receiver comprises a minimum cost algorithm applied to the plurality of nodes and the plurality of edges.

17. The assignment device of claim 16, wherein the minimum cost algorithm is a Floyd-Warshall algorithm adapted for minimum costs.

18. The assignment device of claim 17, wherein the plurality of incoming edges are employed in a first loop of the Floyd-Warshall algorithm and the plurality of outgoing edges are employed in a second loop.

19. The assignment device of claim 15, wherein
each full receiver is further comprised of at least a plurality of incoming edges, such that
the function to determine the minimum cost for each full receiver includes the cost of each incoming edge comprising the full receiver.

20. The assignment device of claim 19, wherein
the Floyd-Warshall algorithm is adapted to determine minimum costs, where
the plurality of incoming edges comprising each open receiver are employed in a first loop of the Floyd-Warshall algorithm, and
the pluralities of outgoing edges and incoming edges comprising each full receiver are employed in a second loop.
